(19) United States
(12) Patent Application Publication
(10) Pub. No.: US 2025/0124670 A1
(43) Pub. Date: Apr. 17, 2025

(54) Dynamic Portals

(71) Applicant: Apple Inc., Cupertino, CA (US)

(72) Inventors: Shaun D. Budhram, Los Gatos, CA (US); Earl M. Olson, Santa Clara, CA (US); Michael J. Gutensohn, San Francisco, CA (US); Siva Chandra Mouli Sivapurapu, Morgan Hill, CA (US)

(21) Appl. No.: 18/898,256

(22) Filed: Sep. 26, 2024

Related U.S. Application Data
(60) Provisional application No. 63/544,586, filed on Oct. 17, 2023.

(51) Int. Cl. G06T 19/00; G06F 3/01

(52) U.S. Cl. CPC G06T 19/006; G06F 3/013

(57) ABSTRACT

In one implementation, a method of displaying a portal is performed by a device including a display, one or more processors, and non-transitory memory. The method includes obtaining a user location in a first three-dimensional coordinate system of a first environment. The method includes obtaining an interest location in a second three-dimensional second coordinate system of a second environment. The method includes transforming the interest location to a transformed interest location in the first three-dimensional coordinate system. The method includes determining a portal location in the first three-dimensional coordinate system based on the user location and the transformed interest location. The method includes displaying, on the display at the portal location, a portal corresponding to at least a partial view of the second environment.

### CROSS-REFERENCE TO RELATED APPLICATIONS

This application claims priority to U.S. Provisional Patent App. No. 63/544,586, filed on Oct. 17, 2023, which is hereby incorporated by reference in its entirety.

### TECHNICAL FIELD

The present disclosure generally relates to systems, methods, and devices of automatically moving a portal in an extended reality (XR) environment.

### BACKGROUND

In various implementations, an extended reality (XR) environment presented by an electronic device includes a portal that displays a portion of a virtual environment. When the user moves from a first location to a second location, the view through the portal changes the portion of the virtual environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-2H illustrate an XR environment during various time periods in accordance with some implementations.

FIG. 3 is a flowchart representation of a method of displaying a portal in accordance with some implementations.

FIG. 4 is a block diagram of an example controller in accordance with some implementations.

FIG. 5 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a portal. In various implementations, the method is performed by a device including a display, one or more processors, and non-transitory memory. The method includes obtaining a user location in a first three-dimensional coordinate system of a first environment. The method includes obtaining an interest location in a second three-dimensional second coordinate system of a second environment. The method includes transforming the interest location to a transformed interest location in the first three-dimensional coordinate system. The method includes determining a portal location in the first three-dimensional coordinate system based on the user location and the transformed interest location. The method includes displaying, on the display at the portal location, a portal corresponding to at least a partial view of the second environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, as a user moves in an XR environment, the view of a virtual world through a portal within the XR environment changes. Thus, as the user moves in the XR environment, a static location may not always be visible through the portal. Similarly, even if the user does not move in the XR environment, a dynamic object that moves in the virtual world may not always be visible through the portal. Accordingly, if a user wishes to maintain a view of static location as the user moves in the XR environment or a dynamic object as the dynamic object moves in the virtual world, the user must also move the portal. However, in various implementations, the portal is automatically moved based on the location of the user in the XR environment and/or the static location or the location of the dynamic object in the virtual world to maintain a view of the static location or dynamic object.

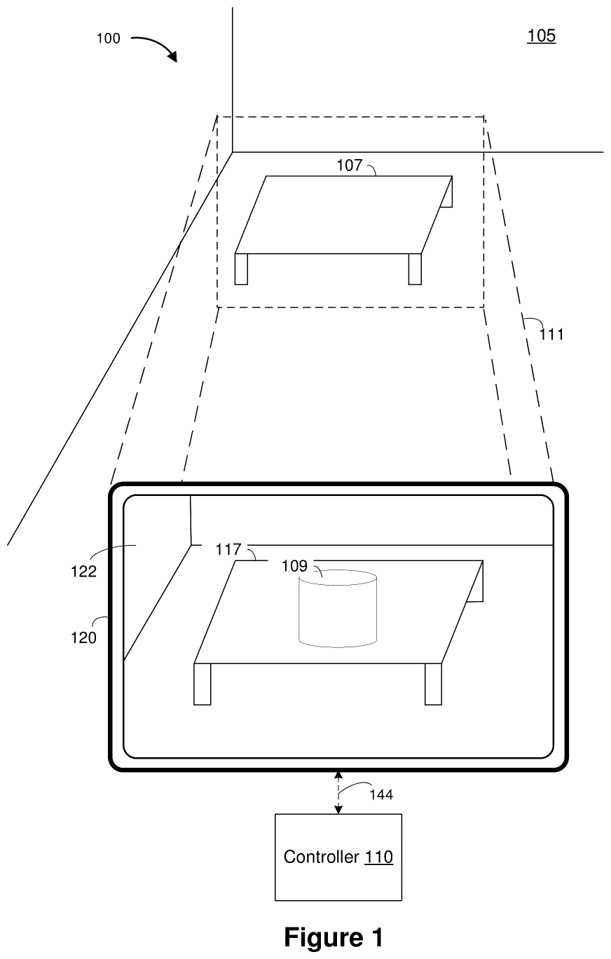

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

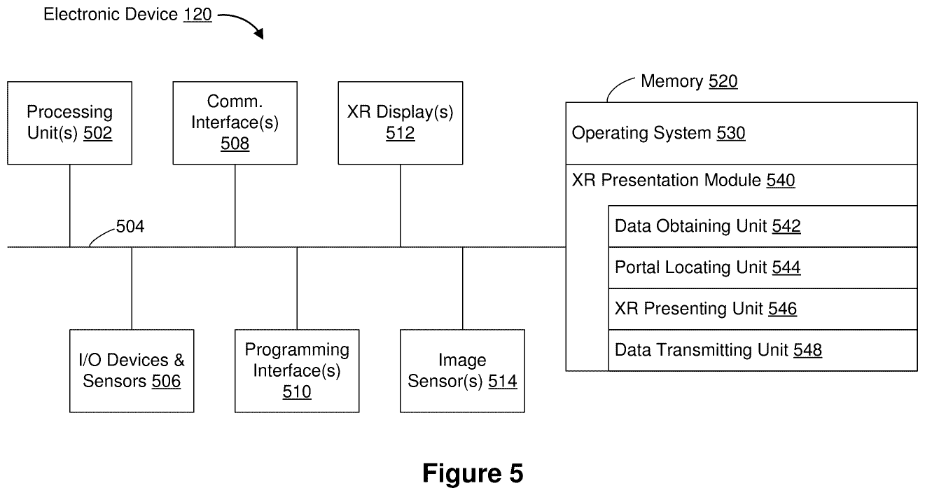

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 5. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 6.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

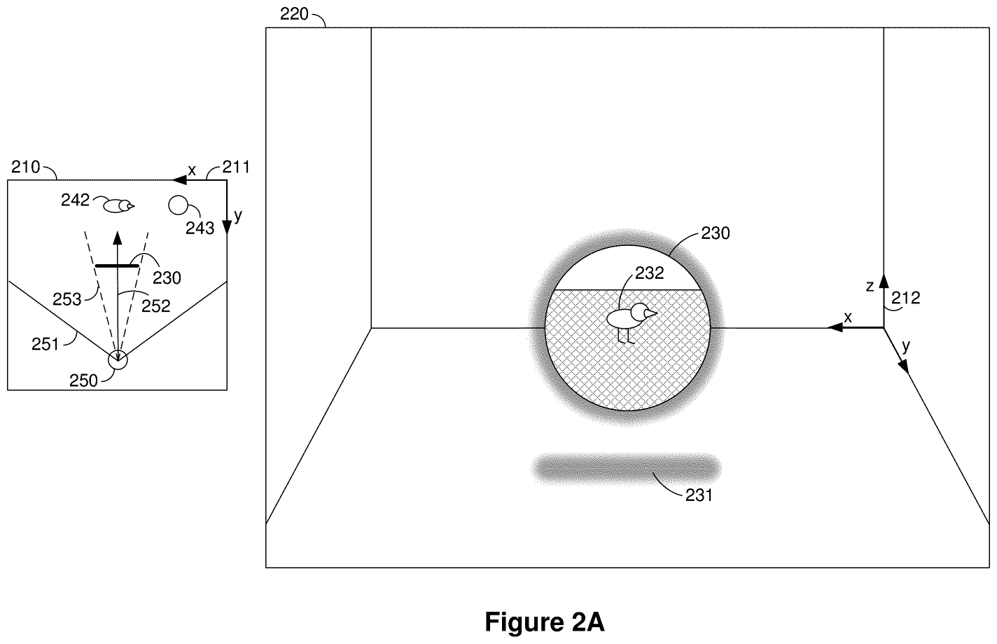

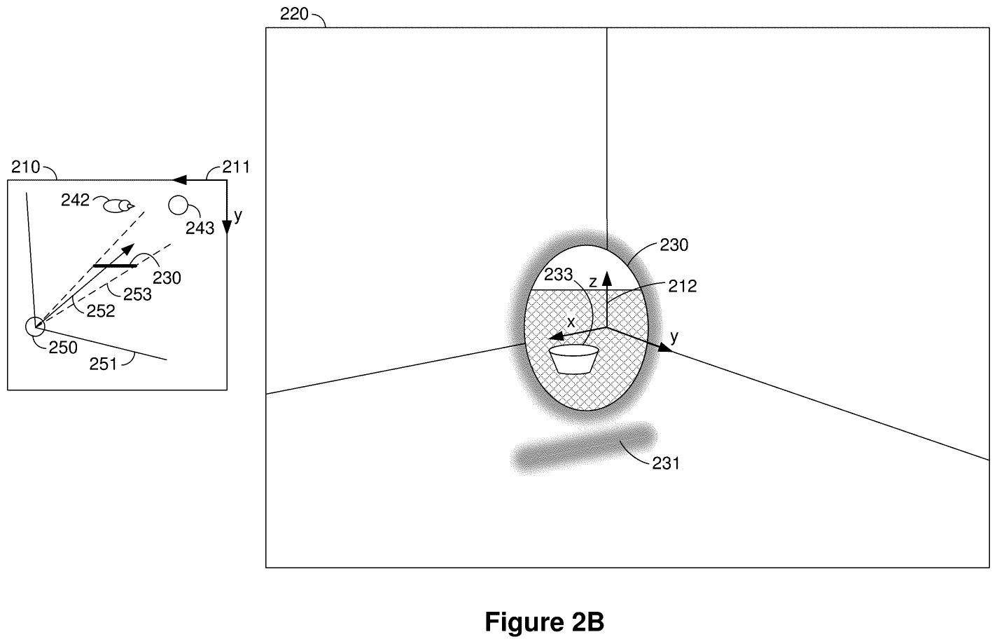

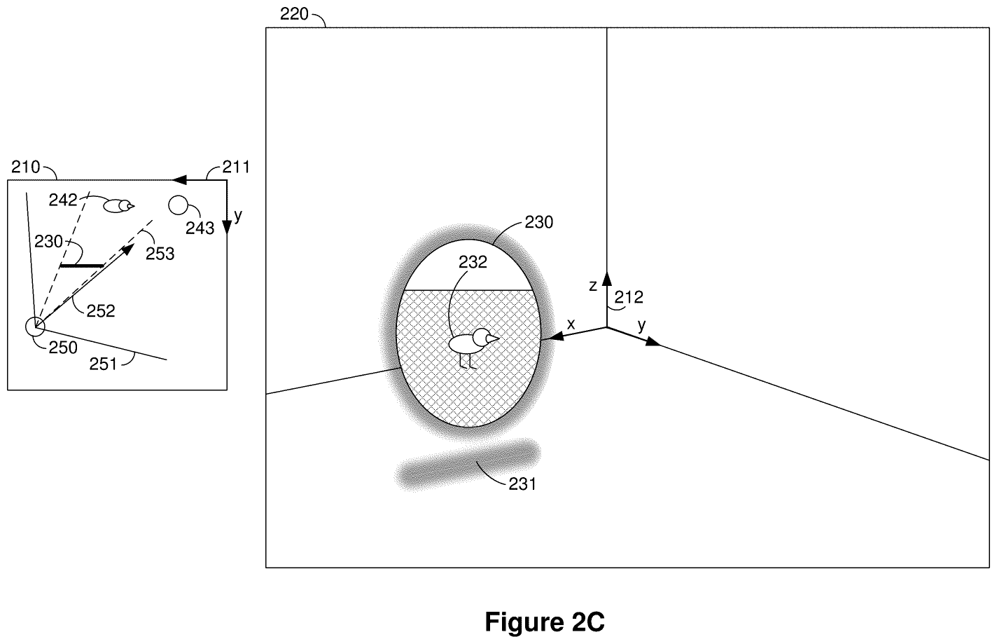

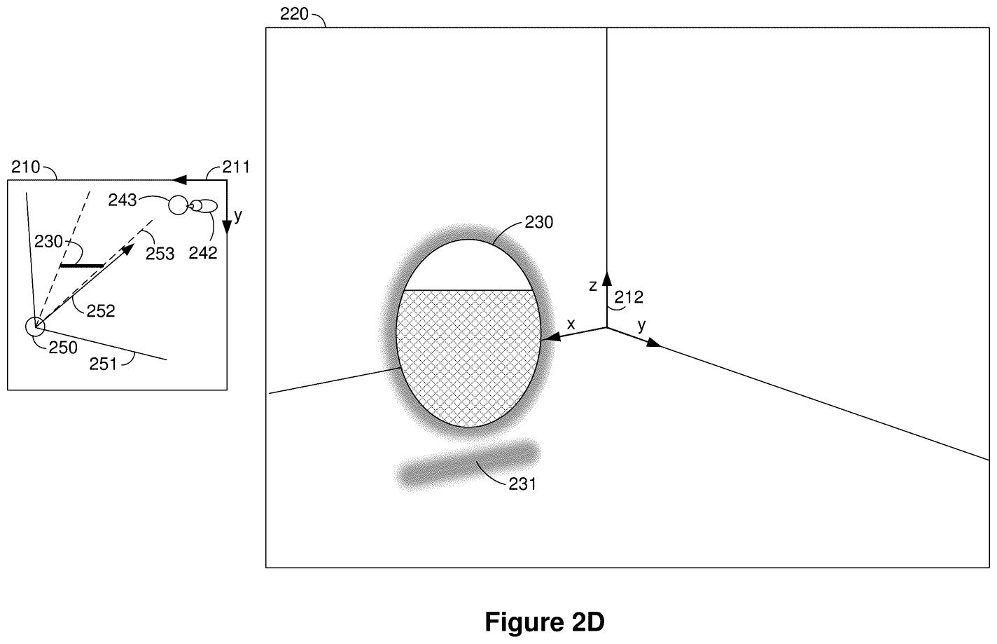

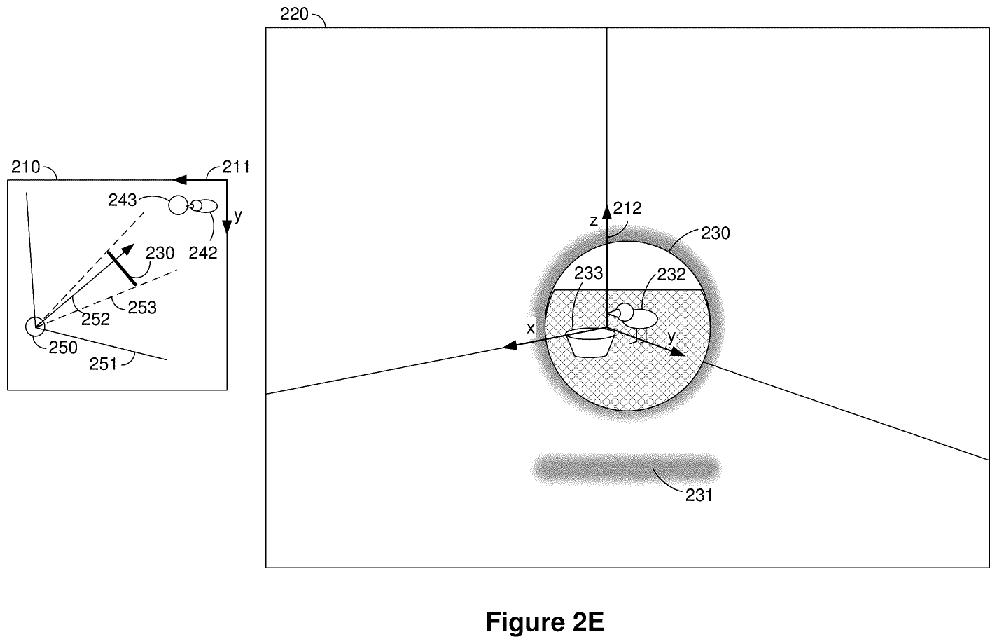

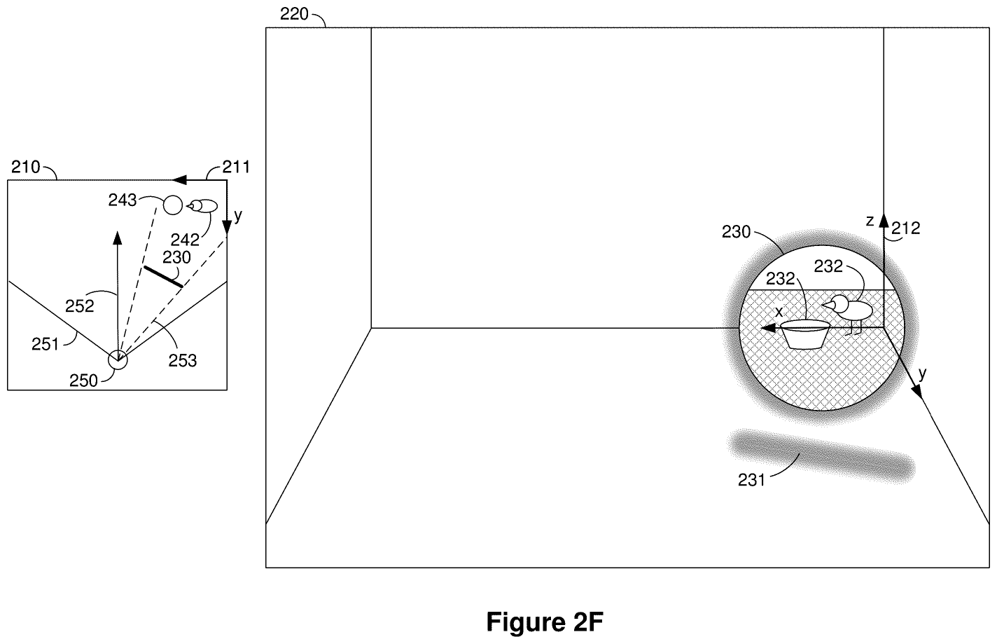

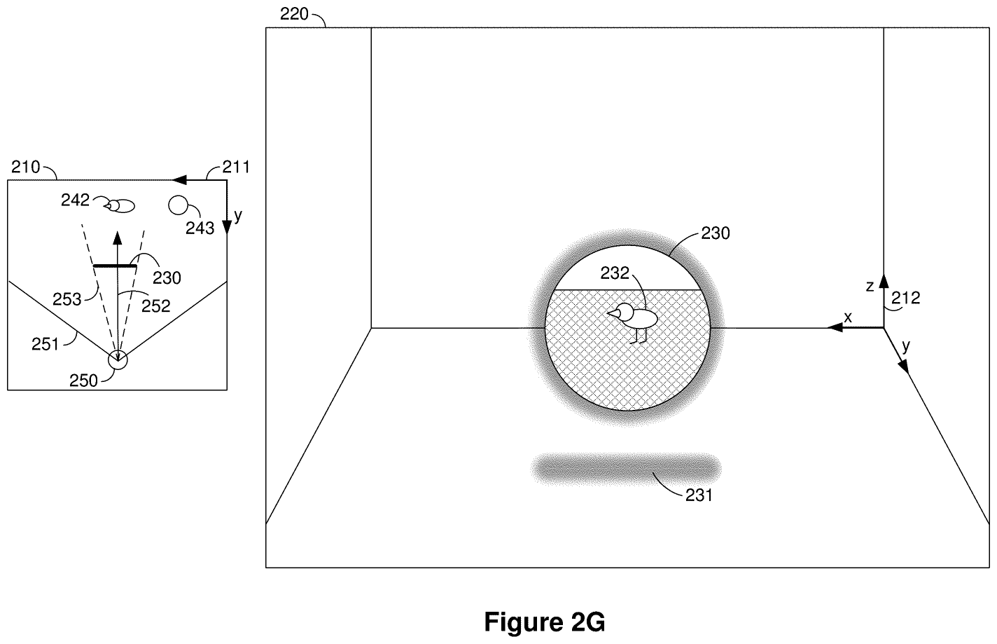

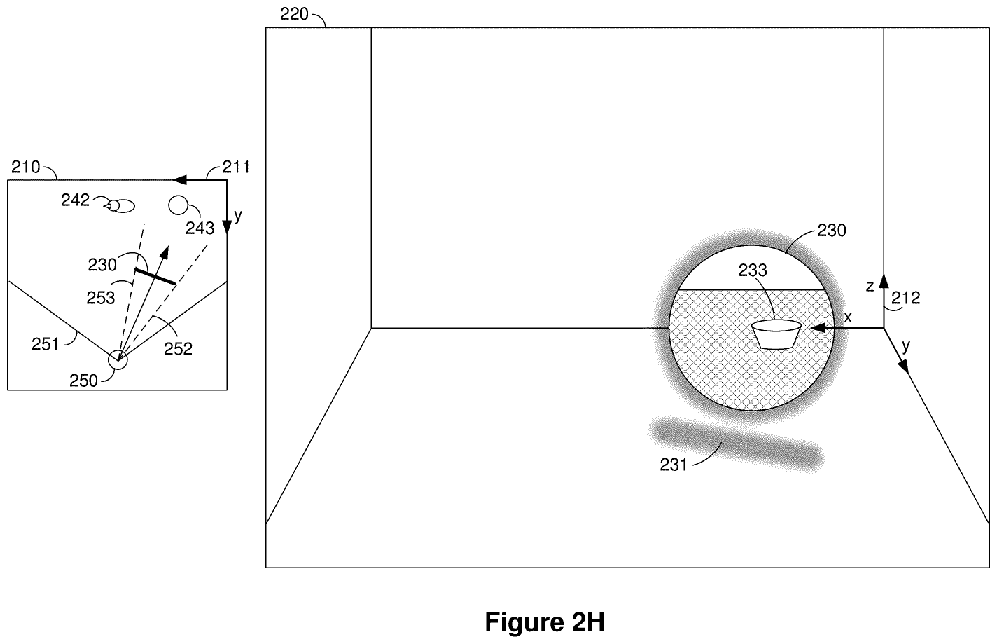

FIGS. 2A-2H illustrate an overhead view 210 and a perspective view 220 of an XR environment generated by an electronic device. The XR environment is based on a physical environment of a room. The overhead view 210 is from an overhead perspective and the perspective view 220 is from a perspective of an eye location of a user and is displayed, at least in part, on a display of the electronic device. The eye location is, for example, where an eye of the user is positioned when the device is head-mounted. For example, in various implementations, the eye location is a fixed distance perpendicularly away from the display.

In various implementations, the electronic device includes multiple displays (e.g., a left display positioned in front of a left eye of the user and a right display positioned in front of a right eye of the user) configured to provide a stereoscopic view of the XR environment. For case of illustration, FIGS. 2A-2H illustrate the XR environment as presented on a single one of the multiple displays.

FIGS. 2A-2H illustrate the overhead view 210 and perspective view 220 of the XR environment during a series of time periods. In various implementations, each time period is an instant, a fraction of a second, a few seconds, a few hours, a few days, or any length of time.

The XR environment is associated with a three-dimensional physical world coordinate system represented by the axes 211 in the overhead view 210 and the axes 212 in the perspective view 220. The XR environment includes a portal 230 which provides a view of a virtual environment. The virtual environment is associated with a three-dimensional virtual world coordinate system which is related to the three-dimensional physical world coordinate system by a rotation-and-translation transform. As illustrated in the perspective view 220, the portal 230 casts a shadow 231 on the floor of the XR environment.

The virtual environment includes, visible through the portal 230 in the perspective view 220 at different time periods, a virtual bird 232 and a virtual bowl 233. The virtual bird 232 is associated with a dynamic set of three-dimensional coordinates in the three-dimensional virtual world coordinate system and the virtual bowl is associated with a static set of three-dimensional coordinates in the three-dimensional world coordinate system. Because the three-dimensional virtual world coordinate system is related by the three-dimensional physical world coordinate system, the virtual bird 232 is also associated with a transformed dynamic set of three-dimensional coordinates in the three-dimensional physical world coordinate system and the virtual bowl 233 is also associated with a transformed static set of three-dimensional coordinates in the three-dimensional physical world coordinate system.

Although the virtual bird 232 and the virtual bowl 233 are not visible in the overhead view 210, a projection of the virtual bird 242 is illustrated in the overhead view 210 at the transformed dynamic set of three-dimensional coordinates and a projection of the virtual bowl 243 is illustrated in the overhead view 210 at the transformed static set of three-dimensional coordinates.

The XR environment further includes the user 250 and the user 250 has a field-of-view 251 and a gaze direction 252 which, although not visible, are illustrated in the overhead view 210. Further, an intersection portion of the field-of-view 253 intersects (and sees through) the portal 230.

FIG. 2A illustrates the overhead view 210 and perspective view 220 of the XR environment during a first time period. During the first time period, the user 250 has a first user location and first user orientation in the XR environment and the portal has a first portal location and first portal orientation in the XR environment.

During the first time period, the intersection portion of the field-of-view 253 includes the projection of the virtual bird 242 and, therefore, the virtual bird 232 is visible through the portal 230 in the perspective view 220. In contrast, during the first time period, the intersection portion of the field-of-view 253 does not include the projection of the virtual bowl 243 and, therefore, the virtual bowl 233 is not visible through the portal 230 in the perspective view 220.

FIG. 2B illustrates the overhead view 210 and the perspective view 220 of the XR environment during a second time period subsequent to the first time period. Between the first time period and the second time period, the user 250 has moved from the first user location and first user orientation to a second user location and a second user orientation (and neither the portal 230 nor the virtual bird 232 has not moved).

During the second time period, the intersection portion of the field-of-view 253 intersects with the projection of the virtual bowl 243, but not the projection of the virtual bird 242. Thus, during the second time period, the virtual bowl 233 is visible through the portal 230 in the perspective view 220, but the virtual bird 232 is not.

FIG. 2C illustrates the overhead view 210 and the perspective view 220 of the XR environment during a third time period subsequent to the second time period. Between the second time period and the third time period, the portal 230 has moved from the first portal location to a second portal location while maintaining the first portal orientation (and neither the user 250 nor the virtual bird 232 has not moved). In various implementations, the portal 230 is moved in response to user input provided by the user 250.

During the third time period, the intersection portion of the field-of-view 253 intersects with the projection of the virtual bird 242, but not the projection of the virtual bowl 243. Thus, during the third time period, the virtual bird 232 is visible through the portal 230 in the perspective view 220, but the virtual bowl 233 is not.

FIG. 2D illustrates the overhead view 210 and the perspective view 220 of the XR environment during a fourth time period subsequent to the third time period. Between the third time period and the fourth time period, the virtual bird 232 has moved from a first bird location in the virtual environment to a second bird location in the virtual environment (and neither the user 250 nor the portal 230 has moved).

During the fourth time period, the intersection portion of the field-of-view 253 does not intersect with either the projection of the virtual bird 242 or the projection of the virtual bowl 243. Thus, during the fourth time period, neither the virtual bird 232 nor the virtual bowl 233 is visible through the portal 230 in the perspective view 220.

FIG. 2E illustrates the overhead view 210 and the perspective view 220 of the XR environment during a fifth time period subsequent to the fourth time period. Between the fourth time period and the third time period, the portal 230 has moved from the second portal location and the first portal orientation to a third portal location and a second portal orientation (and neither the user 250 nor the virtual bird 232 has moved). In various implementations, the portal 230 is moved in response to user input provided by the user 250.

During the fifth time period, the intersection portion of the field-of-view 253 intersects with both the projection of the virtual bird 242 and the projection of the virtual bowl 243. Thus, during the fifth time period, both the virtual bird 232 and the virtual bowl 233 are visible through the portal 230 in the perspective view 220.

Accordingly, as shown in FIGS. 2A-2E, in order to view different virtual objects, the user can either move in the XR environment or move the portal 230. Similarly, in order to maintain view of a static object (such as the virtual bowl 233) while the user moves in the XR environment, the user 250 moves the portal 230. Further, in order to maintain view of a dynamic object (such as the virtual bird 232) even while the user does not move in the XR environment, the user 250 moves the portal 230.

However, in various implementations, the electronic device automatically moves the portal 230 in response to the user moving the XR environment and/or a dynamic object moving in the virtual environment. In particular, the electronic device moves the portal 230 so as to maintain visibility of a particular location in the virtual environment, which may be a dynamic location (such as the location of a dynamic object) or a static location (such as the location of a static object).

During the fifth time period, the electronic device locks the portal 230 to the location of the virtual bowl 233. Accordingly, the electronic device determines a location and orientation for the portal 230 based on the location of the virtual bowl 233 in the virtual environment and the location of the user 250 in the XR environment.

For example, in various implementations, the electronic device determines, for the location of the user 250 in the XR environment, a user set of three-dimensional coordinates in the three-dimensional physical world coordinate system. Further, the electronic device determines, for the location of the virtual bowl 233 in the virtual environment, the static set of three-dimensional coordinates in the virtual world coordinate system and transforms the static set of three-dimensional coordinates using the rotation-and-translation transform into the transformed static set of three-dimensional coordinates in the physical world coordinate system. The electronic device determines a location of the portal 230 as a portal set of three-dimensional coordinates in the three-dimensional physical world coordinate system midway along a line segment between the user set and the transformed static set and determines an orientation of the portal 230 as being perpendicular to the line segment.

FIG. 2F illustrates the overhead view 210 and the perspective view 220 of the XR environment during a sixth time period subsequent to the fifth time period. Between the sixth time period and the fifth time period, the user 250 has moved from the second user location and the second user orientation back to the first user location and the first user orientation (and the virtual bird 232 has not moved).

Because the portal 230 is locked to the location of the virtual bowl 233, in response to the user 250 moving to a different location, the electronic device automatically moves the portal 230 from the third portal location and the second portal orientation to a fourth portal location and a third portal orientation.

During the sixth time period, the intersection portion of the field-of-view 253 intersects with both the projection of the virtual bird 242 and the projection of the virtual bowl 243. Thus, during the sixth time period, both the virtual bird 232 and the virtual bowl 233 is visible through the portal 230 in the perspective view 220.

During the sixth time period, the electronic device locks the portal 230 to the location of the virtual bird 232. Accordingly, the electronic device determines a location and orientation for the portal 230 based on the location of the virtual bird 232 in the virtual environment and the location of the user 250 in the XR environment.

FIG. 2G illustrates the overhead view 210 and the perspective view 220 of the XR environment during a seventh time period subsequent to the sixth time period. Between the seventh time period and the sixth time period, the virtual bird 242 has moved from the second bird location in the virtual environment back to the first bird location (and the user 250 has not moved).

Because the portal 230 is locked to the location of the virtual bird 232, in response to the virtual bird 232 moving to a different location, the electronic device automatically moves the portal 230 from the fourth portal location and the third portal orientation back to the first portal location and the first portal orientation.

During the seventh time period, the intersection portion of the field-of-view 253 intersects with the projection of the virtual bird 242, but does not intersect with the projection of the virtual bowl 243. Thus, during the seventh time period, the virtual bird 232 is visible through the portal 230 in the perspective view 220, but the virtual bowl 233 is not.

During the seventh time period, the electronic device locks the portal 230 to the location of the gaze point of the user 250, e.g., the location in the virtual environment that intersects the gaze direction 252. Accordingly, the electronic device determines a location and orientation for the portal 230 based on the location of the gaze point of the user 250 in the virtual environment and the location of the user 250 in the XR environment.

FIG. 2H illustrates the overhead view 210 and the perspective view 220 of the XR environment during an eighth time period subsequent to the seventh time period. Between the eighth time period and the seventh time period, the user 250 looks to the right, changing the gaze direction 252 without changing location or orientation (and the virtual bird 232 does not move).

Because the portal 230 is locked to the location of the gaze point of the user 250, in response to the change in gaze direction 252, the electronic device automatically moves the portal 230 from the first portal location and the first portal orientation to a fifth portal location and a fourth portal orientation.

During the eighth time period, the intersection portion of the field-of-view 253 intersects with the projection of the virtual bowl 243, but does not intersect with the projection of the virtual bird 242. Thus, during the eighth time period, the virtual bowl 233 is visible through the portal 230 in the perspective view 220, but the virtual bird 232 is not.

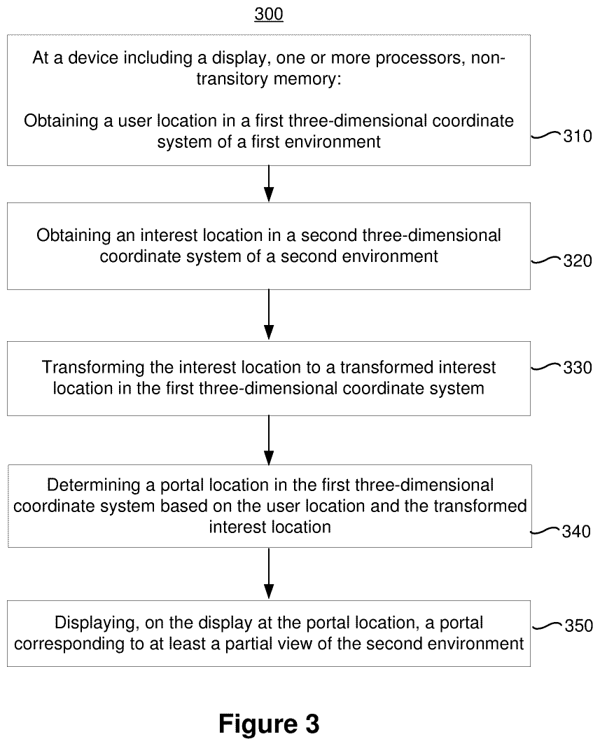

FIG. 3 is a flowchart representation of a method 300 of displaying a portal in accordance with some implementations. In various implementations, the method 300 is performed by an electronic device, such as the electronic device 120 of FIG. 1. In various implementations, the method 300 is performed by a device with a display, one or more processors, and non-transitory memory. In some implementations, the method 300 is performed by processing logic, including hardware, firmware, software, or a combination thereof. In some implementations, the method 300 is performed by a processor executing instructions (e.g., code) stored in a non-transitory computer-readable medium (e.g., a memory).

The method 300 begins, in block 310, with the device obtaining a user location in a first three-dimensional coordinate system of a first environment. In various implementations, the user location includes a user set of three-dimensional coordinates in the first three-dimensional coordinate system. In various implementations, the first environment is a physical environment including one or more physical objects. In various implementations, the first environment is a virtual environment including one or more virtual objects.

The method 300 continues, in block 320, with the device obtaining an interest location in a second three-dimensional coordinate system of a second environment. In various implementations, the interest location includes an interest set of three-dimensional coordinates in the second three-dimensional coordinate system. In various implementations, the second environment is a virtual environment including one or more virtual objects.

In various implementations, the interest location is a location of a static object in the second environment. For example, in FIG. 2F, the location of the portal 230 based on the location of the static virtual bowl 233. In various implementations, the interest location is a location of dynamic object in the second environment. For example, in FIG. 2G, the location of the portal 230 is based on the location of the dynamic virtual bird 232. In various implementations, the interest location is a gaze point of a user in the second environment. For example, in FIG. 2H, the location of the portal 230 is based on the gaze direction 252. In various implementations, the gaze portion of the user is the location of an object in the second environment the user is looking at. In various implementations, the gaze point is determined as the intersection of a gaze direction of the user transformed from the first three-dimensional coordinate system to the second three-dimensional coordinate system.

The method 300 continues, in block 330, with the device transforming the interest location (in the second three-dimensional coordinate system) into a transformed interest location in the first three-dimensional coordinate system. In various implementations, the transformed interest location includes a transformed interest set of three-dimensional coordinates in the first three-dimensional coordinate system. In various implementations, the first three-dimensional coordinate system and the second three-dimensional coordinate system are related by coordinate system transform. In various implementations, the coordinate system transform is a rotation-and-translation transform. For example, in various implementations, the transform is stored as a set of three angles and three distances. In various implementations, the three angles and three distances are all zero and the coordinate system transform is an identity transform. In various implementations, the coordinate system transform can be changed via user input.

The method 300 continues, in block 340, with the device determining a portal location in the first three-dimensional coordinate system based on the user location and the transformed interest location. In various implementations, the portal location includes a portal set of three-dimensional coordinates in the first three-dimensional coordinate system. In various implementations, the portal location is a point of a line segment between the user location and the transformed interest location. In various implementations, the portal location is a point of the line segment that is a predetermined distance from the user location. In various implementations, the predetermined distance can be changed via user input. In various implementations, the portal location is a point of the line segment that is a predetermined distance from the transformed interest location. In various implementations, the predetermined distance can be changed via user input. In various implementations, the portal location is a point of the line segment that is a distance from the user location that is a predetermined percentage of the distance between user location and the transformed interest location. For example, in various implementations, the predetermined percentage is 50 percent and the portal location is a midpoint of the line segment. In various implementations, the predetermined percentage can be changed via user input.

In various implementations, the method 300 further includes determining a portal orientation in the first three-dimensional coordinate system based on the user location and the transformed interest location. For example, in various implementations, the portal orientation is perpendicular to the line segment between the user location and the transformed interest location. In various implementations, the portal size is a predetermined size. In various implementations, the predetermined size can be changed via user input. However, in various implementations, the method 300 further includes determining a portal size based on the user location and the transformed interest location. For example, in various implementations, the portal size is based on a distance between the user location and the portal location. For example, in various implementations, the portal size is an increasing function of the distance between the user location and the portal location, such that the portal size increases as the user gets further away from the portal.

The method 300 continues, in block 350, with the device displaying, on the display at the portal location, a portal corresponding to at least a partial view of the second environment. In various implementations, displaying the portal includes rendering the portal and compositing the rendering with an image of a physical environment. In various implementations, rendering the portal includes determining a portal area in a two-dimensional coordinate system of the display. For example, in various implementations, the portal has a portal shape, a portal size, a portal location, and a portal orientation that define a set of points in the first three-dimensional coordinate system and determining the portal area includes projecting the set of points into the two-dimensional coordinate system based on the user location. In various implementations, rendering the portal includes determining a pixel value for each pixel of the portal area. In various implementations, determining the pixel value includes transforming the user location into a transformed user location in the second three-dimensional coordinate system based on the coordinate system transform and rendering the second environment for the pixel from the transformed user location (e.g., via ray-tracing from the transformed user location through the location of the pixel into the second environment).

In various implementations, the location of the portal is dynamically updated based on the user moving the first environment and/or a dynamic object moving the second environment. Thus, in various implementations, the method 300 further includes obtaining an updated user location in a first three-dimensional coordinate system; determining an updated portal location in the first three-dimensional coordinate system based on the updated user location and the transformed interest location; and displaying, on the display at the updated portal location, the portal.

In various implementations, the method 300 further includes obtaining an updated interest location in the second three-dimensional coordinate system; transforming the updated interest location to an updated transformed interest location in the first three-dimensional coordinate system; determining an updated portal location in the first three-dimensional coordinate system based on the user location and the updated transformed interest location; and displaying, on the display at the updated portal location, the portal.

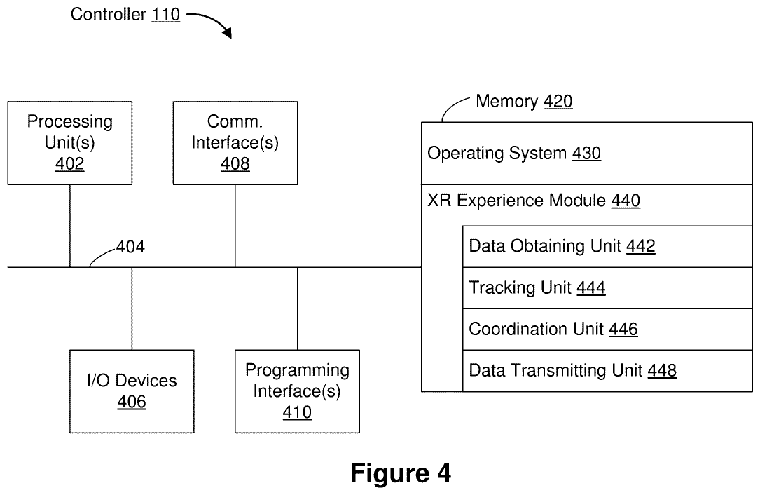

FIG. 4 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 402 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 406, one or more communication interfaces 408 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 410, a memory 420, and one or more communication buses 404 for interconnecting these and various other components.

In some implementations, the one or more communication buses 404 include circuitry that interconnects and controls communications between system components. In some implementations, the one or more I/O devices 406 include at least one of a keyboard, a mouse, a touchpad, a joystick, one or more microphones, one or more speakers, one or more image sensors, one or more displays, and/or the like.

The memory 420 includes high-speed random-access memory, such as dynamic random-access memory (DRAM), static random-access memory (SRAM), double-data-rate random-access memory (DDR RAM), or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores the following programs, modules and data structures, or a subset thereof including an optional operating system 430 and an XR experience module 440.

The operating system 430 includes procedures for handling various basic system services and for performing hardware dependent tasks. In some implementations, the XR experience module 440 is configured to manage and coordinate one or more XR experiences for one or more users (e.g., a single XR experience for one or more users, or multiple XR experiences for respective groups of one or more users). To that end, in various implementations, the XR experience module 440 includes a data obtaining unit 442, a tracking unit 444, a coordination unit 446, and a data transmitting unit 448.

In some implementations, the data obtaining unit 442 is configured to obtain data (e.g., presentation data, interaction data, sensor data, location data, etc.) from at least the electronic device 120 of FIG. 1. To that end, in various implementations, the data obtaining unit 442 includes instructions and/or logic therefor, and heuristics and metadata therefor.

In some implementations, the tracking unit 444 is configured to map the physical environment 105 and to track the position/location of at least the electronic device 120 with respect to the physical environment 105 of FIG. 1. To that end, in various implementations, the tracking unit 444 includes instructions and/or logic therefor, and heuristics and metadata therefor.

In some implementations, the coordination unit 446 is configured to manage and coordinate the XR experience presented to the user by the electronic device 120. To that end, in various implementations, the coordination unit 446 includes instructions and/or logic therefor, and heuristics and metadata therefor.

In some implementations, the data transmitting unit 448 is configured to transmit data (e.g., presentation data, location data, etc.) to at least the electronic device 120. To that end, in various implementations, the data transmitting unit 448 includes instructions and/or logic therefor, and heuristics and metadata therefor.

Although the data obtaining unit 442, the tracking unit 444, the coordination unit 446, and the data transmitting unit 448 are shown as residing on a single device (e.g., the controller 110), it should be understood that in other implementations, any combination of the data obtaining unit 442, the tracking unit 444, the coordination unit 446, and the data transmitting unit 448 may be located in separate computing devices.

Moreover, FIG. 4 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 5 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 510, one or more XR displays 512, one or more optional interior- and/or exterior-facing image sensors 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 512 are configured to provide the XR experience to the user. In some implementations, the one or more XR displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 512 correspond to diffractive, reflective, polarized, holographic, etc. waveguide displays. For example, the electronic device 120 includes a single XR display. In another example, the electronic device includes an XR display for each eye of the user. In some implementations, the one or more XR displays 512 are capable of presenting MR and VR content.

In some implementations, the one or more image sensors 514 are configured to obtain image data that corresponds to at least a portion of the face of the user that includes the eyes of the user (any may be referred to as an eye-tracking camera). In some implementations, the one or more image sensors 514 are configured to be forward-facing so as to obtain image data that corresponds to the physical environment as would be viewed by the user if the electronic device 120 was not present (and may be referred to as a scene camera). The one or more optional image sensors 514 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR presentation module 540.

The operating system 530 includes procedures for handling various basic system services and for performing hardware dependent tasks. In some implementations, the XR presentation module 540 is configured to present XR content to the user via the one or more XR displays 512. To that end, in various implementations, the XR presentation module 540 includes a data obtaining unit 542, a portal locating unit 544, an XR presenting unit 546, and a data transmitting unit 548.

In some implementations, the data obtaining unit 542 is configured to obtain data (e.g., presentation data, interaction data, sensor data, location data, etc.) from at least the controller 110 of FIG. 1. To that end, in various implementations, the data obtaining unit 542 includes instructions and/or logic therefor, and heuristics and metadata therefor.

In some implementations, the portal locating unit 544 is configured to determine a portal location based on a user location. To that end, in various implementations, the portal locating unit 544 includes instructions and/or logic therefor, and heuristics and metadata therefor.

In some implementations, the XR presenting unit 546 is configured to display a portal at the determined portal location via the one or more XR displays 512. To that end, in various implementations, the XR presenting unit 546 includes instructions and/or logic therefor, and heuristics and metadata therefor.

In some implementations, the data transmitting unit 548 is configured to transmit data (e.g., presentation data, location data, etc.) to at least the controller 110. In some implementations, the data transmitting unit 548 is configured to transmit authentication credentials to the electronic device. To that end, in various implementations, the data transmitting unit 548 includes instructions and/or logic therefor, and heuristics and metadata therefor.

Although the data obtaining unit 542, the portal locating unit 544, the XR presenting unit 546, and the data transmitting unit 548 are shown as residing on a single device (e.g., the electronic device 120), it should be understood that in other implementations, any combination of the data obtaining unit 542, the portal locating unit 544, the XR presenting unit 546, and the data transmitting unit 548 may be located in separate computing devices.

Moreover, FIG. 5 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having a display, one or more processors, and non-transitory memory;
obtaining a user location in a first three-dimensional coordinate system of a first environment;
obtaining an interest location in a second three-dimensional coordinate system of a second environment;
transforming the interest location to a transformed interest location in the first three-dimensional coordinate system;
determining a portal location in the first three-dimensional coordinate system based on the user location and the transformed interest location; and
displaying, on the display at the portal location, a portal corresponding to at least a partial view of the second environment.

2. The method of claim 1, wherein the first environment is a physical environment and the second environment is a virtual environment.

3. The method of claim 1, wherein the interest location is a location of a static object in the second environment.

4. The method of claim 1, wherein the interest location is a location of a dynamic object in the second environment.

5. The method of claim 1, wherein the interest location is a gaze point of a user.

6. The method of claim 1, wherein the portal location is a point of a line segment between the user location and the transformed interest location.

7. The method of claim 6, wherein the portal location is a point of the line segment that is a predetermined distance from the user location.

8. The method of claim 6, wherein the portal location is a point of the line segment that is a predetermined distance from the transformed interest location.

9. The method of claim 6, wherein the portal location is a point of the line segment that is a distance from the user location that is a predetermined percentage of a distance between the user location and the transformed interest location.

10. The method of claim 9, wherein the predetermined percentage is 50 percent and the portal location is a midpoint of the line segment.

11. The method of claim 1, further including determining a portal orientation in the first three-dimensional coordinate system based on the user location and the transformed interest location.

12. The method of claim 11, wherein the portal orientation is perpendicular to a line segment between the user location and the transformed interest location.

13. The method of claim 1, further including determining a portal size based on the user location and the transformed interest location.

14. The method of claim 13, wherein the portal size is based on a distance between the user location and the portal location.

15. The method of claim 1, further including:
obtaining an updated user location in the first three-dimensional coordinate system;
determining an updated portal location in the first three-dimensional coordinate system based on the updated user location and the transformed interest location; and
displaying, on the display at the updated portal location, the portal.

16. The method of claim 1, further including:
obtaining an updated interest location in the second three-dimensional coordinate system;
transforming the updated interest location to an updated transformed interest location in the first three-dimensional coordinate system;
determining an updated portal location in the first three-dimensional coordinate system based on the user location and the updated transformed interest location; and
displaying, on the display at the updated portal location, the portal.

17. A device comprising:
a display;
a non-transitory memory; and
one or more processors to:
obtain a user location in a first three-dimensional coordinate system of a first environment;
obtain an interest location in a second three-dimensional second coordinate system of a second environment;
transform the interest location to a transformed interest location in the first three-dimensional coordinate system;
determine a portal location in the first three-dimensional coordinate system based on the user location and the transformed interest location; and
display, on the display at the portal location, a portal.

18. The device of claim 17, wherein the first environment is a physical environment and the second environment is a virtual environment.

19. The device of claim 17, wherein the portal location is a point of a line segment between the user location and the transformed interest location.

20. A non-transitory memory storing one or more programs, which, when executed by one or more processors of a device including a display, cause the device to:
obtain a user location in a first three-dimensional coordinate system of a first environment;
obtain an interest location in a second three-dimensional second coordinate system of a second environment;
transform the interest location to a transformed interest location in the first three-dimensional coordinate system;
determine a portal location in the first three-dimensional coordinate system based on the user location and the transformed interest location; and
display, on the display at the portal location, a portal.
